(19) United States
(12) Patent Application Publication
(10) Pub. No.: US 2021/0179926 A1
(43) Pub. Date: Jun. 17, 2021

(54) METHODS, PRODUCTS & USES RELATING TO SCAVENGING OF ACIDIC SULFIDE SPECIES

(71) Applicant: Innospec Limited, Ellesmere Port, Cheshire (GB)

(72) Inventor: Philip Maltas, Ellesmere Port, Cheshire (GB)

(73) Assignee: Innospec Limited, Ellesmere Port, Cheshire (GB)

(21) Appl. No.: 17/270,391

(22) PCT Filed: Aug. 21, 2019
(86) PCT No.: PCT/GB2019/052353

§ 371 Date: Feb. 22, 2021

(30) Foreign Application Priority Data
Aug. 22, 2018 (GB) 1813647.3

(51) Int. Cl. C09K 8/54; C09K 8/52; C10G 29/26; C10G 75/00; C10L 3/10; C10G 29/20; B01D 53/14; B01D 53/52; B01D 53/78; C02F 1/28

(52) U.S. Cl. CPC C09K 8/54; C02F 2101/101; C10G 29/26; C10G 75/00; C10L 3/103; C10G 29/20; B01D 53/1468; B01D 53/1493; B01D 53/52; B01D 53/78; C02F 1/288; C09K 2208/20; C09K 2208/32; C09K 2208/28; C10G 2300/207; B01D 2252/2053; B01D 2252/606; C02F 1/285; C09K 8/52

(57) ABSTRACT

The use of the combination of (a) an imine compound and (b) a compound including a soft electrophilic centre to scavenge and retain acidic sulfide species at a higher temperature and/or scavenge acidic sulfide species at an increased rate compared to that achieved using the imine compound alone.

The present invention relates to methods for improving the scavenging of acidic sulfide species hydrogen sulfide (H₂S). In particular the invention relates to scavenging hydrogen sulfide at a higher temperature and/or an increased rate.

Hydrogen sulfide and other acidic sulfide species are known to be formed within the oil reservoir and thus they are an issue throughout the petroleum industry. They are an issue during the exploration, drilling, fracturing, completion, production, storage and transport of crude oil and natural gas. For example, crude oil, natural gas, produced water from within the well, used fracturing fluids, used water-flooding fluids and used drilling muds all may contain hydrogen sulfide.

Hydrogen sulfide and other acidic sulfide species are also problematic during the processing of crude oil, where it is liberated by processes such as hydro-processing, cracking and coking. Furthermore, they are known to be present in liquids, distillation residues such as asphalt or bitumen and solids, such as coke, that are present in petroleum refineries. The acidic sulfide species may be present in petroleum refinery liquids such as liquid products, by-products, intermediates and waste streams.

Hydrogen sulfide and other acidic sulfide species are not just problematic for the petroleum industry. These compounds are also known to be present in waste waters, sewage, the effluent from tanneries and paper mills, geothermal fluids and thus geothermal power plants.

Hydrogen sulfide is highly toxic. It is very corrosive and can quickly damage machinery, storage tanks and pipelines. It is also poisonous to many catalysts.

It is therefore desirable to remove hydrogen sulfide and other acidic sulfide species from such materials, or at least reduce the levels present. Various methods of removing hydrogen sulfide and other acidic sulfide species are known. One such method is the use of hydrogen sulfide scavengers, which react selectively with hydrogen sulfide in an attempt to remove it from the material.

The removal of hydrogen sulfide from crude oil may occur at various points during the production and processing operations. For example, the hydrogen sulfide may be removed from within the wellbore or during above ground processing, such as during the storage and/or transportation of crude oil. The hydrogen sulfide scavengers may also be used during the refining process.

A number of hydrogen sulfide scavengers are currently used in industry. These may be based on organic compounds, bases, metal oxides, metal chelates or oxidising agents. Examples of commonly used organic hydrogen sulfide scavengers include aldehydes and protected aldehydes such as acetals, and nitrogen based scavengers such as amines, triazines and imine compounds. For example US2018/0030360 describes the use of compounds of formula:

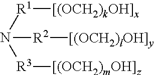

in combination with Michael acceptors as scavengers and antifoulants. One or more of x, y or z may be 0 and one or two of R¹, R² and R³ may be hydrogen.

Metal oxides, metal chelates and oxidising agents are known to react with hydrogen sulfide to form adducts with high thermal stability. However, such adducts are often insoluble solids which may cause blockage during production. Some oxidising scavengers also result in the formation of SOₓ^{y-} species, which may cause corrosion and pipeline damage or solid sulfur deposits which can cause blockages.

Some organic hydrogen sulfide scavengers form adducts that are unstable at higher temperatures, often re-releasing hydrogen sulfide gas when heated. Some organic hydrogen sulfide scavengers have slow reaction rates meaning long contact times are needed.

This can be an issue, for example, when scavengers are used in pipelines at low temperatures and the product is later heated, for example in a refinery. This subsequent heating can cause toxic, corrosive sulfide species such as hydrogen sulfide to be re-released.

For example, some commonly used imine based scavengers can re-release H₂S when heated to 140° C.

There is therefore a need to improve the thermal stability and/or reaction rate of organic hydrogen sulfide scavengers, as well as avoiding the formation of precipitates and corrosive by-products.

According to a first aspect of the present invention there is provided the use of the combination of (a) an imine compound and (b) a compound including a soft electrophilic centre to scavenge and retain acidic sulfide species at a higher temperature and/or scavenge acidic sulfide species at an increased rate compared to that achieved using the imine compound alone.

The present invention relates to the scavenging of an acidic sulfide species.

By acidic sulfide species we mean to refer to any compound including a sulfur atom having a −2 oxidation state bound to an acidic hydrogen atom or the conjugate base thereof. The conjugate base refers to the anion formed on removal of the acidic hydrogen atom.

Suitable acidic sulfide species include H₂S; compounds containing the ions HS⁻ or S²⁻; and any compound or ion containing the functional groups —SH, —S⁻, —S—SH, —S—S⁻, —SₙH, —S₍ₙ₋₁₎S⁻.

Suitable acidic sulfide species include hydrogen sulfide (H₂S) or its anion (HS⁻), sulfide anion (S²⁻); thiols (RSH) and their conjugate base (RS⁻); hydrodisulfides (R—S—S—H) and their conjugate base (R—S—S⁻); or hydropolysulfides (RSₙH) and their conjugate base (RSₙ₋₁S⁻). R may be, for example, an optionally substituted alkyl, alkenyl, aryl, aralkyl, alkaryl or heterocyclic group. However it will be appreciated that the specific nature of the R group is unimportant since it is the sulfur containing functional group that is scavenged.

Preferably the acidic sulfide species is selected from hydrogen sulfide (H₂S), sulfide anion (S²⁻); hydrosulfide ion (HS⁻); compounds including a thiol group (—SH) and their conjugate base (—S⁻).

Preferably the present invention relates to the scavenging of hydrogen sulfide or a source thereof in a sample. By hydrogen sulfide or a source thereof we mean to refer to hydrogen sulfide or a compound which readily generates hydrogen sulfide. Compounds which generate hydrogen sulfide include the thiol, disulfide and polysulfide species mentioned above.

Suitably the present invention relates to the scavenging of hydrogen sulfide.

Thus in especially preferred embodiments the present invention provides the use of the combination of (a) an imine compound and (b) a compound including a soft electrophilic centre to scavenge and retain hydrogen sulfide at a higher temperature and/or scavenge hydrogen sulfide at an increased rate compared to that achieved using the imine compound alone.

The present invention relates to the use of (a) an imine compound in combination with (b) a compound including a soft electrophilic centre.

Component (a) may comprise any imine compound.

Suitable imine compounds for use herein include compounds of formula (I):

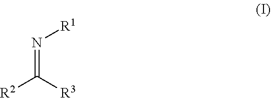

in which each of R¹, R² and R³ is independently selected from hydrogen or an optionally substituted alkyl, alkenyl, aryl, alkaryl or aralkyl group. Suitably at least one of R¹, R² and R³ is not hydrogen.

Each of R¹, R² and R³ may include a cyclic group.

Suitably each of R¹, R² and R³ is independently hydrogen or an alkyl, alkenyl, aryl, alkaryl or aralkyl group having 1 to 24, preferably 1 to 20, suitably 1 to 16 carbon atoms.

Each of R¹, R² and R³ may include a cyclic moiety.

Two or three of the groups R¹, R² and R³ may be joined to form one or more cyclic groups. Such cyclic groups may further comprise one or more additional hetero atoms such as sulfur or especially oxygen.

In some embodiments the imine compound may comprise more than one imine functional group.

In some embodiments the imine compound may include one or more further non-imine functional groups.

In preferred embodiments each of R¹, R² and R³ is independently selected from hydrogen or an unsubstituted alkyl, alkenyl, aryl, alkaryl or aralkyl group.

Preferably at least one of R¹, R² and R³ is not hydrogen.

Preferably at least one of R¹, R² and R³ is hydrogen.

Preferred imines for use in component (a) are aliphatic imine compounds.

Preferably each of R¹, R² and R³ is independently selected from hydrogen or an unsubstituted alkyl group.

Such alkyl groups may be straight chain or branched. Branched alkyl groups are preferred.

Preferably each of R¹, R² and R³ is independently selected from hydrogen or an unsubstituted alkyl group having 1 to 30 carbon atoms, preferably 1 to 24 carbon atoms, suitably 2 to 20 carbon atoms, for example 2 to 16 carbons atoms, preferably wherein at least one of R¹, R² and R³ is hydrogen and at least one is not hydrogen.

Preferably each of R¹, R² and R³ is independently selected from hydrogen or an unsubstituted branched alkyl group having 1 to 30 carbon atoms, preferably 1 to 24 carbon atoms, suitably 2 to 20 carbon atoms, for example 2 to 16 carbons atoms, preferably wherein at least one of R¹, R² and R³ is hydrogen and at least one is not hydrogen.

Preferably at least one of R² and R³ is hydrogen.

Suitably R² may be hydrogen or an optionally substituted alkyl group. Preferably R² is hydrogen or an unsubstituted alkyl group, more preferably hydrogen or a branched unsubstituted alkyl group, suitably having 4 to 12, preferably 6 to 10, for example 8 carbon atoms.

Preferably R¹ is not hydrogen. Preferably R¹ is an alkyl group, preferably an unsubstituted branched alkyl group, especially having 1 to 22, for example 2 to 16 carbon atoms. Most preferably R¹ is an unsubstituted branched alkyl group having 4 to 14 carbon atoms.

Preferably component (a) comprises one or more imine compounds of formula (I) in which R¹ is a branched unsubstituted alkyl group having 1 to 20, preferably 4 to 14 carbon atoms, one of R² and R³ is hydrogen and the other of R² and R³ is hydrogen or a branched unsubstituted alkyl group having 1 to 20, preferably 6 to 10 carbon atoms.

The imine compounds of formula (I) are suitably prepared by reacting an amine of formula R¹NH₂ with a carbonyl compound of formula R²R³C═O. The carbonyl compound may be an aldehyde (in which at least one of R² and R³ is hydrogen) or a ketone (in which neither of R² and R³ is hydrogen).

In some embodiments a diimine may be formed from a dialdehyde or a diketone.

Preparation of imines from amines and aldehydes or ketones is well known to those skilled in the art.

Suitable imine compounds for use herein are described in U.S. Pat Nos. 5,169,411 and 4,778,609.

Preferably the imine compounds of formula (I) are prepared by reacting a branched alkyl amine and an aldehyde.

In some embodiments the imine compound of formula (I) is the reaction product of an amine of formula R¹NH₂ and formaldehyde (or paraformaldehyde). In such embodiments R² and R³ are both hydrogen.

As the skilled person will appreciate commercial sources of primary amines may comprise a mixture of homologues. Imines prepared from such amines will comprise a mixture of compounds of formula (I) in which different groups R¹ are present.

Imines prepared from mixtures of aldehydes or ketones may also be used. Such compounds will include mixtures in which different R² and R³ groups are present.

In some embodiments the imine compound is prepared by the reaction of an aldehyde or ketone, preferably an aldehyde, especially formaldehyde (or paraformaldehyde), with tertiary alkyl amine.

In some preferred embodiments the imine compound is prepared by the reaction of an aldehyde or ketone, preferably an aldehyde, especially formaldehyde (or paraformaldehyde), with one or more compounds of formula (II):

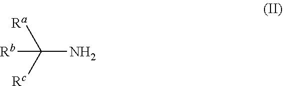

wherein each of R^{a}, R^{b} and R^{c} is an optionally substituted alkyl group having 1 to 16, preferably 1 to 12 carbon atoms

Preferred compounds are those in which R^{a}, R^{b} and R^{c} are unsubstituted alkyl groups, especially those in which groups R^{a}, R^{b} and R^{c} together comprise 3 to 22 carbon atoms. Most preferably groups R^{a}, R^{b} and R^{c} together comprise 12 to 14 carbon atoms.

One especially preferred imine compound for use herein is the reaction product of formaldehyde (or paraformaldehyde) and a mixture of compounds of formula (II) in which groups R^{a}, R^{b} and R^{c} are alkyl groups which together comprise 12 to 14 carbon atoms. This imine has the structure shown in formula (III):

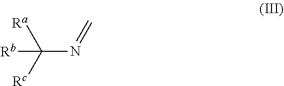

In some preferred embodiments the imine compound has the formula R^{d}—C(CH₃)₂—N═CH₂, also shown as (IV):

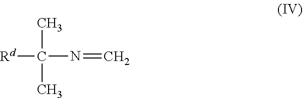

wherein R^{d} is a C₁ to C₁₀, preferably a C₁ to C₅ alkyl group.

Examples of suitable imine compounds of formula (IV) are as follows:

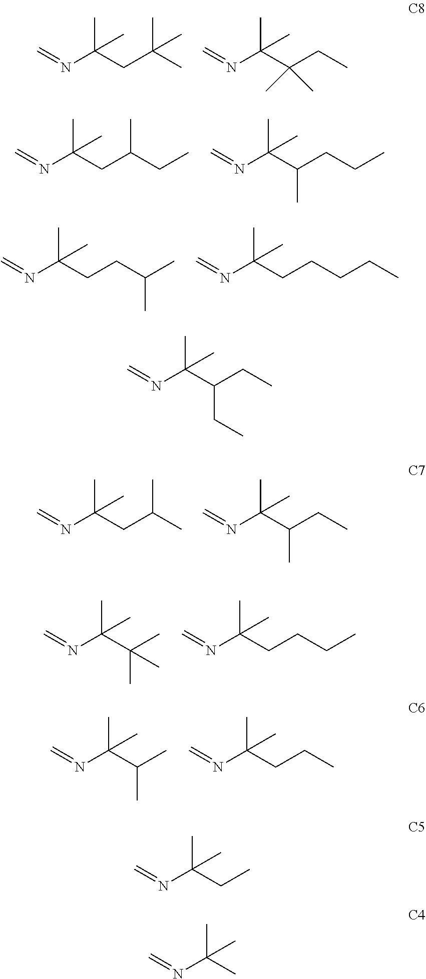

Mixtures of imine compounds having the formula R^{d}—C(CH₃)₂—N═CH₂ may also be used.

Suitably, in the formula R^{d}—C(CH₃)₂—N═CH₂, R^{d} represents a methyl group or a 5C alkyl group. For example, the imine compound may be tert-butylimine or tert-octylimine or mixtures thereof. More particularly R^{d} represents a 5C alkyl group and the imine compound may be tert-octylimine.

Suitably the imine compound may be an imine compound prepared from tert-butyl amine and formaldehyde (or paraformaldehyde). This may be referred to herein as tert-butylimine.

Suitably, the imine compound may be an imine compound prepared from tert-octyl amine ((CH₃)₃CCH₂C(CH₃)₂NH₂) and formaldehyde (or paraformaldehyde). This compound may be referred to herein as tert-octylimine.

In a further preferred embodiment the imine compound comprises the reaction product of a branched aldehyde having more than 3 carbon atoms and a branched unsubstituted alkylamine. In one especially preferred embodiment the imine compound is the reaction product of tert-butylamine and 2-ethyl hexanal. This imine has the structure shown in formula (V):

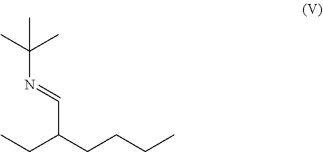

In some preferred embodiments the imine compound is prepared by the reaction of one or more compounds of formula (II):

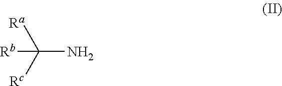

and an aldehyde selected from formaldehyde (or paraformaldehyde) and 2-ethyl hexanal wherein each of R^{a}, R^{b} and R^{c} is an unsubstituted alkyl group and the groups R^{a}, R^{b} and R^{c} together comprise 3 to 22 carbon atoms.

In preferred embodiments component (a) comprises an imine compound selected from one or more compounds of formula (III), (IV) or (V):

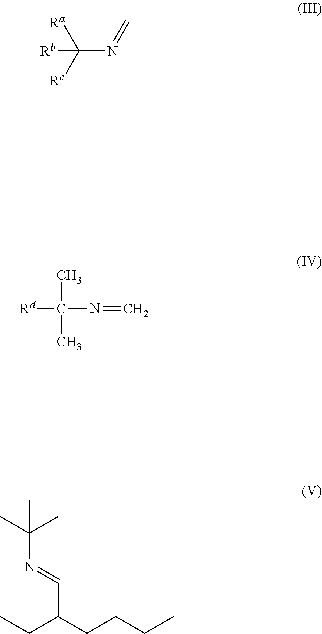

wherein groups R^{a}, R^{b} and R^{c} together comprise 12 to 14 carbon atoms; and R^{d} is a (1-5C)alkyl group.

Preferably component (a) comprises an imine compound selected from one or more of a compound of formula (III), the compound of formula (V) and tert-octylimine.

Component (a) is used in combination with component (b), a compound including a soft electrophilic centre.

By electrophilic centre we mean to refer to an electron deficient atom that can be attacked by a nucleophile.

The electrophilic centre may be defined as hard or soft according to the Pearson hard and soft acids and bases (HSAB) theory.

By soft electrophilic centre we mean to refer to an electron deficient atom characterised by a high polarizability, low electronegativity and low charge density.

The compound including a soft electrophilic centre is preferably an organic compound.

Suitably the soft electrophilic centre is an electron deficient carbon atom.

In some embodiments the electron deficient carbon atom is bonded to a halide, for example Cl, Br and I.

In some embodiments the electron deficient carbon atom may be bonded to a halogen atom, for example selected from Br and I.

In some embodiments component (b) may comprise a compound of formula (VI):

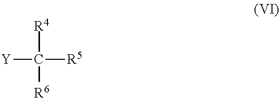

wherein Y is a halogen, and R⁴, R⁵ and R⁶ may each independently be selected from hydrogen, a halogen, an oxygenated functional group or an optionally substituted hydrocarbyl group.

Preferably Y is I or Br.

Suitable oxygenated functional groups include carboxylic acids, esters, amides, imides, imines, aldehydes, ketones and other carbonyl or imine derived functional groups.

In some preferred embodiments Y is Br and at least one of R⁴, R⁵ and R⁶ is hydrogen. In such embodiments two of R⁴, R⁵ and R⁶ may be hydrogen.

One especially preferred compound having a soft electrophilic centre of formula (VI) is 2-bromoethanoic acid, wherein R⁴ is COOH and R⁵ and R⁶ are H.

In some preferred embodiments Y is I and at least one of R⁴, R⁵ and R⁶ is a halogen-containing group. In such embodiments none of R⁴, R⁵ and R⁶ may be hydrogen.

One especially preferred compound having a soft electrophilic centre of formula (VI) is 2-lodo-1,1,1,2,3,3,3-heptafluoropropane, wherein R⁴ is F and R⁵ and R⁶ are both CF₃.

In some embodiments the electron deficient carbon atom of the soft electrophilic centre is bonded to a chlorine atom. Although simple alkyl halides are generally not regarded as soft electrophiles, compounds in which a carbon atom bonded to a chlorine atom is adjacent to a further stabilising functional groups may be regarded as a soft electrophilic centre within the definition of component (b) of the present invention.

In some embodiments the compound having a soft electrophilic centre may comprise a halogen substituent adjacent to a carbonyl group.

For example component (b) may comprise a compound of formula (XI):

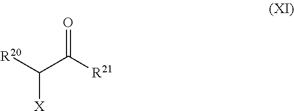

wherein X is Cl, Br or I, R²⁰ is selected from hydrogen, an optionally substituted hydrocarbyl group, COR²² or COOR²³; and R²¹ is hydrogen, an optionally substituted hydrocarbyl group, OR²⁴ or NR²⁵R²⁵ wherein each of R²², R²³,R²⁴, R²⁵ and R²⁶ may be hydrogen or an optionally substituted hydrocarbyl group.

Preferably X is Cl or Br.

Preferably R²¹ is an optionally substituted alkyl group or a group of formula OR²⁴ wherein R²⁴ is an optionally substituted alkyl group.

Preferably R²¹ is an optionally unsubstituted alkyl group or OR²⁴ wherein R²⁴ is an unsubstituted alkyl group.

R²⁰ is preferably hydrogen, COR²² or COOR²³ wherein R²² or R²³ is an optionally substituted alkyl group, preferably an unsubstituted alkyl group.

Preferred compounds of formula (XI) include 3-chloro-2-butanone, chloroacetic anhydride, dimethyl bromomalonate, diethyl bromomalonate and chloroacetic acid.

Suitably the compound including a soft electrophilic centre may be an α, β-unsaturated carbonyl compound or a reactive equivalent thereof, for example an α, β-unsaturated ketone, ester, carboxylic acid, amide, anhydride, aldehyde, acetal or imide.

In some embodiments the compound including a soft electrophilic centre may be an aldehyde. Preferably any such compound does not include two adjacent aldehyde functional groups. For the avoidance of doubt glyoxal is not considered to be a compound including a soft electrophilic centre within the meaning of the present invention. In preferred embodiments component (b) does not comprise glyoxal.

Preferred aldehydes for use in component (b) are aliphatic aldehydes.

In some preferred embodiments the compound including a soft electrophilic centre is an α, β-unsaturated carbonyl compound of formula (VII), (VIII) or (IX):

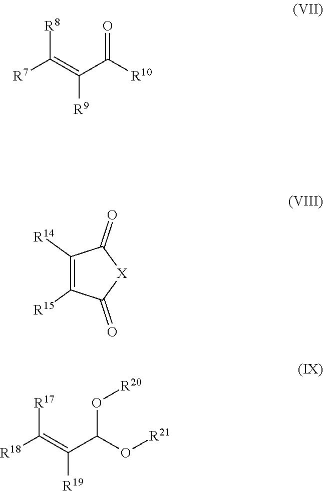

wherein each of R⁷, R⁸ R⁹, R¹⁷, R¹⁸ and R¹⁹ is independently selected from hydrogen and an optionally substituted hydrocarbyl group; R¹⁰ is selected from hydrogen, an optionally substituted hydrocarbyl group, OR¹¹ and NR¹²R¹³; each of R¹⁴ and R¹⁵ is selected from hydrogen and an optionally substituted hydrocarbyl group; each of R²⁰ and R²¹ is an optionally substituted hydrocarbyl group and X is O or NR¹⁶; wherein R¹¹ is an optionally substituted hydrocarbyl group; and each of R¹², R¹³ and R¹⁶ is hydrogen, an optionally substituted hydrocarbyl group, OH, NH₂ or CONH₂.

In some embodiments R¹⁶ is hydrogen or an optionally substituted hydrocarbyl group.

Preferably each of R⁷, R⁸ and R⁹ is hydrogen or an optionally substituted alkyl group.

Preferably each of R⁷, R⁸ and R⁹ is hydrogen or an unsubstituted alkyl group.

Preferably each R⁷, R⁸ and R⁹ is hydrogen or an unsubstituted alkyl group having 1 to 20 carbon atoms, preferably 1 to 10 carbon atoms, suitably 1 to 4 carbon atoms.

Preferably R⁹ is hydrogen or methyl.

Preferably at least one of R⁷ and R⁸ is hydrogen.

In some embodiments R⁷, R⁸ and R⁹ are all hydrogen. _{R}¹⁰ is preferably OR¹¹, H or an optionally substituted alkyl group.

When R¹⁰ is an optionally substituted alkyl group, it preferably has 1 to 10, more preferably 1 to 4 carbon atoms. When R¹⁰ is an alkyl group it is preferably an unsubstituted alkyl group.

When R¹⁰ is OR¹¹, R¹¹ is preferably an optionally substituted alkyl group. Preferably R¹¹ is an unsubstituted alkyl group. Preferably R¹¹ has 1 to 10 carbon atoms, more preferably 1 to 4 carbon atoms.

Most preferably R¹⁰ is hydrogen.

In preferred embodiments the compound of formula (VII) is an α, β-unsaturated aldehyde, such that R¹⁰ is hydrogen and R⁷, R⁸ and R⁹ may be independently selected from hydrogen or a hydrocarbyl group.

In especially preferred embodiments the compound of formula (VII) is propenal and R⁷, R⁸, R⁹ and R¹⁰ are all hydrogen. Propenal is also known as acrolein.

Preferably each of R¹⁴ and R¹⁵ is hydrogen or an optionally substituted alkyl group. Preferably each of R¹⁴ and R¹⁵ is hydrogen or an unsubstituted alkyl group having 1 to 20 carbon atoms, preferably 1 to 10 carbon atoms, suitably 1 to 4 carbon atoms.

In some preferred embodiments each of R¹⁴ and R¹⁵ is hydrogen.

In one preferred embodiment X is O, R¹⁴ and R¹⁵ are both hydrogen and the compound of (VI) comprises maleic anhydride.

Preferably X is NR¹⁶. R¹⁶ may be hydrogen or an optionally substituted hydrocarbyl group.

In some embodiments R¹⁶ is a substituted hydrocarbyl group. In some embodiments R¹⁴ and R¹⁵ are both hydrogen, X is NR¹⁶ and R¹⁶ is selected from hydrogen, CH₂CH₂OH, CONH₂, CH₂COOH and OH.

Other suitable maleimide-derived compounds which may be provided in component (b) include the compound of formula (XII) and the compound of formula (XIII):

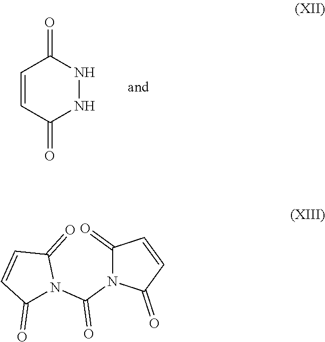 [SMILES: O=c1ccc(=O)[nH][nH]1 ; O=C1C=CC(=O)N1C(=O)N1C(=O)C=CC1=O]

Preferably X is NR¹⁶. Preferably R¹⁶ is hydrogen or an optionally substituted alkyl group. Preferably R¹⁶ is hydrogen or an unsubstituted alkyl group having 1 to 20 carbon atoms, preferably 1 to 10 carbon atoms, suitably 1 to 4 carbon atoms.

In one preferred embodiment R¹⁴ is hydrogen, R¹⁵ is hydrogen, and R¹⁶ is butyl and the compound of formula (VIII) is N-butyl maleimide.

Most preferably R¹⁴, R¹⁵ and R¹⁶ is hydrogen, and the compound of formula (VIII) is maleimide.

Preferably each of R¹⁷, R¹⁸ and R¹⁹ is hydrogen or an optionally substituted alkyl group.

Preferably each of R¹⁷, R¹⁸ and R¹⁹ is hydrogen or an unsubstituted alkyl group.

Preferably each of R¹⁷, R¹⁸ and R¹⁹ is hydrogen or an unsubstituted alkyl group having 1 to 20 carbon atoms, preferably 1 to 10 carbon atoms, suitably 1 to 4 carbon atoms.

Preferably R¹⁹ is hydrogen.

Preferably at least one of R¹⁷ and R¹⁸ is hydrogen.

In some embodiments R¹⁷, R¹⁸ and R¹⁹ are all hydrogen.

Each of R²⁰ and R²¹ is an optionally substituted hydrocarbyl group. In some embodiments R²⁰ and R²¹ may together form a cyclic group.

Preferably each of R²⁰ and R²¹ is an optionally substituted alkyl group.

Preferably each of R²⁰ and R²¹ is an unsubstituted alkyl group.

Each of R²⁰ and R²¹ may be an unsubstituted alkyl group having 1 to 4 carbon atoms.

Preferably R²⁰ and R²¹ together form an unsubstituted alkylene group, i.e. a group of formula (CH₂)ₙ. Preferably n is 2 and the compound of formula (IX) is 2-vinyl-1,3-dioxolane, the compound of formula (IXA):

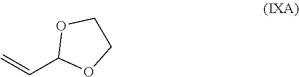

In some preferred embodiments the compound including a soft electrophilic centre is a silane. Suitable silanes are compounds of formula (X):

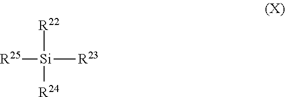

wherein each of R²², R²³, R²⁴ and R²⁵ is an optionally substituted hydrocarbyl group.

Preferably each of R₂₂, R²³, R²⁴ and R²⁵ is an optionally substituted alkyl group.

Preferably each of R²², R²³, R²⁴ and R²⁵ is an optionally substituted alkyl group having 1 to 30 carbon atoms, preferably 1 to 20 carbon atoms, more preferably 1 to 12 carbon atoms, suitably 1 to 6 carbon atoms, for example 1 to 4 carbon atoms.

Preferably each of R²², R²³, R²⁴ and R²⁵ is an unsubstituted alkyl group or an alkyl group substituted with a halogen.

Preferably each of R²², R²³, R²⁴ and R²⁵ is an unsubstituted alkyl group or a chloroalkyl group.

Preferably each of R²², R²³, R²⁴ and R²⁵ is an unsubstituted C1 to C4 alkyl group or a C1 to C4 chloroalkyl group.

Preferably each of R²², R²³, R²⁴ and R²⁵ is selected from methyl and chloromethyl.

One especially preferred silane compound is bis(chloromethyl)dimethyl silane, the compound of formula (XA):

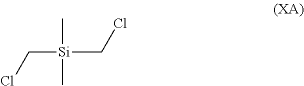

Suitably component (b) comprises a compound including a soft electrophilic centre selected from halogenated compounds including an electron deficient carbon atom, bromo-compounds, iodo-compounds, silanes and α, β-unsaturated carbonyl compounds or a reactive equivalent thereof.

Suitably component (b) comprises a compound including a soft electrophilic centre selected from bromo-compounds, iodo-compounds, silanes and α, β-unsaturated carbonyl compounds or a reactive equivalent thereof.

Suitably component (b) comprises a compound including a soft electrophilic centre selected from bromo-compounds, iodo-compounds, silanes and α, β-unsaturated ketones, esters, carboxylic acids, amides, anhydrides, aldehydes, acetals or imides.

Suitably component (b) comprises a compound including a soft electrophilic centre selected from compounds of formula (VI), compounds of formula (VII), compounds of formula (VIII), compounds of formula (IX), compounds of formula (X) and compounds of formula (XI).

Suitably component (b) comprises a compound including a soft electrophilic centre selected from compounds of formula (VI), compounds of formula (VII), compounds of formula (VIII), compounds of formula (IX) and compounds of formula (X).

Component (b) may comprise a compound including a soft electrophilic centre selected from propenal, maleimide, N-butyl maleimide, bis(chloromethyl)dimethyl silane, 2-iodo-1,1,1,2,3,3,3-heptafluoropropane, maleic anhydride and 2-vinyl-1,3-dioxolane.

Component (b) may comprise a compound including a soft electrophilic centre selected from propenal, maleimide, N-butyl maleimide, bis(chloromethyl)dimethyl silane, 2-iodo-1,1,1,2,3,3,3-heptafluoropropane and 2-vinyl-1,3-dioxolane.

Most preferably component (b) comprises a compound including a soft electrophilic centre selected from α, β-unsaturated aldehydes and optionally substituted maleimides.

Preferably component (b) comprises a compound having a soft electrophilic centre selected from propenal, N-butyl maleimide, maleimide and 2-vinyl-1,3-dioxolane.

In some embodiments component (b) is selected from propenal, maleimide, maleic anhydride and mixtures thereof.

Preferably component (b) comprises propenal and/or maleimide.

Most preferably component (b) comprises propenal.

In some embodiments the present invention involves the combination of (a) an imine compound; and (b) a compound including a soft electrophilic centre selected from α, β-unsaturated aldehydes, maliec anhydride and maleimides.

In preferred embodiments the present invention involves the combination of (a) an imine compound; and (b) a compound including a soft electrophilic centre selected from α, β-unsaturated aldehydes and maleimides.

According to a second aspect of the present invention there is provided a method of scavenging acid sulfide species from an industrial or environmental material, the method comprising contacting the material with:
(a) an imine compound; and
(b) a compound including a soft electrophilic centre.

According to a third aspect of the present invention there is provided a product for scavenging acid sulfide species, the product comprising:
(a) an imine compound; and
(b) a compound including a soft electrophilic centre.

According to the first aspect of the present invention the combination of (a) the imine compound and (b) the compound including a soft electrophilic centre scavenges and retains acidic sulfic species, for example hydrogen sulfide, at a higher temperature and/or an increased rate compared to when the imine compound alone is used.

By scavenging acidic sulfide species we mean to refer to the removal or reduction of the amount of acidic sulfide species present in a material.

By retains acidic sulfide species we mean that the acid sulfide species are not readily re-released.

Suitably the first aspect relates to the use of the combination of (a) the imine compound and (b) the compound including a soft electrophilic centre to scavenge and retain acidic sulfide species, for example hydrogen sulfide, from an industrial or environmental material.

One problem of the prior art is that some hydrogen sulfide scavengers re-release hydrogen sulfide at high temperatures, for example at temperatures greater than 140° C.

The claimed combination of component (a) and component (b) may scavenge and retain acidic sulfide species, for example hydrogen sulfide at higher temperatures relative to the temperature at which the imine compound scavenges and retains the acidic sulfide species when it is used alone.

Without being bound by theory, it is believed than the compound including a soft electrophilic centre may interact with the imine compound to form an activated intermediate. Such an activated intermediate may then interact with hydrogen sulfide to form one or more products and/or adducts that are thermally stable at higher temperatures than those formed with the imine compound. However this is a non-limiting suggestion and several other reaction pathways are possible.

Suitably the combination of the imine compound (a) and the compound including the soft electrophilic centre (b) scavenges and retains acid sulfide species for example hydrogen sulfide at temperatures of at least 150° C. Preferably the combination scavenges and retains acidic sulfate species, for example hydrogen sulfide at temperatures of at least 160° C., for example at temperatures of at least 165° C. or 170° C. Most preferably the combination scavenges and retains acidic sulfide species, for example hydrogen sulfide at temperatures of at least 180° C.

Thus the present invention suitably provides the use of (a) an imine compound in combination with (b) a compound including a soft electrophilic centre to scavenge and retain acidic sulfide species at temperatures of at least 150° C., for example of at least 180° C. Suitably the acidic sulfide species is retained at temperatures of at least 150° C., for example of at least 180° C. for at least 5 minutes, and preferably less than 5 ppm H₂S is released. The acidic sulfide species (for example hydrogen sulfide) may be retained at temperatures of at least 150° C. for at least 15 minutes. Retention may be measured according to the test method ASTM 2420-13.

The use of (a) an imine compound in combination with (b) a compound including a soft electrophilic centre may increase the rate at which acidic sulfide species are scavenged.

By the rate at which an acidic sulfide compound is scavenged and retained we mean to refer to the change in concentration of the acidic sulfide species over time. The increase in rate is relative to the rate at which the imine compound scavenges an acidic sulfide species when used alone.

Suitably the use of the combination of (a) an imine compound and (b) a compound including a soft electrophilic centre scavenges and retains the acid sulfide species present in an industrial or environmental material at an increased rate under identical conditions of temperature and concentration than would be achieved using the imine compound alone. Suitably the time period to reduce the acidic sulfide species concentration by the same amount at the same temperature using the combination is less than half the time period when using the imine compound alone.

Particularly advantageous results have been shown for embodiments in which the imine is either a compound of formula (III) or t-octylimine and the compound including a soft electrophilic centre is propenal: when 5 molar equivalents each of propenal and imine (per mole of H₂S) are used, substantially all of the hydrogen sulfide in the industrial or environmental material is scavenged within 30 minutes at 30° C.

The second aspect of the invention relates to a method of scavenging acid sulfide species from an industrial or environmental material.

The industrial or environmental material may include solids, liquids or gasses that are obtained from any industries or environments where hydrogen sulfide may be present.

The industrial material may be a product, by-product, intermediate or waste stream obtained from an industry and may be solid or a fluid, such as liquid or a gas. For example, the industrial material may be sourced from an oil well, a petroleum refinery, the cargo hold of a vehicle transporting crude oil or petroleum products, an oil pipeline, a farm slurry pit, sewage works, paper mill or tannery.

The industrial or environmental material may be selected from fluids in or extracted from an oil well; products, by-products, intermediates and waste streams from refineries and other industries; water; sewage; and geothermal fluids.

Fluids in or extracted from an oil well may be selected from: crude oil; gas condensate; gas; sour gas; produced water; drilling fluids; fracturing fluids and water flooding fluids.

The drilling fluids and fracturing fluids may preferably be selected from drilling fluids in use, used drilling fluids, fracturing fluids in use and used fracturing fluids.

The products, by-products, intermediates and waste streams from refineries and other industries may be solids or fluids such as liquids or gases.

Other industries may be selected from biofuel production, farming, tanneries, paper mills and power.

In one embodiment, the industrial or environmental material may be selected from: gas condensate; gas; drilling fluids in use; used drilling fluids; fracturing fluids in use; used fracturing fluids; solid products, by-products, intermediates and waste streams from refineries; fluid products, by-products, intermediates and waste streams from refineries; and solid and liquid products, by-products, intermediates and waste streams from other industries such as biofuel production, farming, tanneries, paper mills and power.

In a preferred embodiment, the industrial or environmental material is selected from crude oil, produced water, petroleum refinery liquids, coke, asphalt or bitumen, used fracturing fluids, used water-flooding fluids, brines, geothermal fluids or sour gas.

The present invention may be useful for scavenging acidic sulfide species, for example hydrogen sulfide, from crude oil.

In one preferred embodiment the industrial or environmental material comprises crude oil.

The present invention is particularly useful for scavenging and retaining acidic sulfide species from hydrocarbonaceous industrial or environmental materials.

Typically the industrial or environmental material may comprise up to 1000 mg of hydrogen sulfide per litre (L) of material. In some embodiments, the industrial or environmental material contains up to 500 mg/L, or for example up to 200 mg/L of hydrogen sulfide. It may contain up to 150 mg/L or 100 mg/L of hydrogen sulfide. For example, the industrial or environmental material may contain 0.1 to 100 mg/L of hydrogen sulfide.

In the method of the second aspect (a) the imine compound and (b) the compound including a soft electrophilic centre may be added to the material in a single composition or they may be provided in separate compositions. Preferably they are provided in separate compositions.

In the method of the second aspect (a) the imine compound and (b) the compound including a soft electrophilic centre may be added to the material in a single composition or they may be provided in separate compositions. Preferably they are provided in separate compositions.

When component (a), the imine compound, and component (b), the compound including a soft electrophilic centre, are contacted with each other they suitably form one or more reaction products. Depending on the conditions at which they are contacted, the reaction product(s) may either be in the form of a liquid or a solid.

Thus in embodiments in which component (a) and component (b) are added to the industrial or environmental material in a single composition the conditions are suitably selected to prevent or reduce the formation of solid reaction product(s). Preferably in such embodiments the imine compound (a) and the compound including a soft electrophilic centre (b) are mixed at 0° C. to form the single composition. When a single composition is used, it is preferably rapidly contacted with the industrial or environmental fluid as the performance may decrease with time.

Preferably component (a) and component (b) are provided in separate compositions.

Suitably the amounts of (a) the imine compound and (b) the compound including a soft electrophilic centre added to the industrial or environmental material is dependent on various factors, for example the amount of acidic sulfide species, for example hydrogen sulfide, present in the material; the desired final level of acidic sulfide species in the material; the exact natures of the imine compound and the compound including a soft electrophilic centre; the reaction time needed to achieve the desired level of acidic sulfide species and the temperature of the environmental or industrial material.

The selection of appropriate conditions will be within the competence of the person skilled in the art.

Suitably the composition comprising an imine compound may be contacted with the industrial or environmental material before the composition comprising a compound including a soft electrophilic centre is contacted with the industrial or environmental material. Alternatively the composition comprising an imine compound may be contacted with the industrial or environmental material after the composition comprising a compound including a soft electrophilic centre is contacted with the industrial or environmental material.

Preferably the industrial or environmental material is contacted concurrently with a composition comprising an imine compound and a composition comprising a compound including a soft electrophilic centre.

The method of the second aspect preferably involves adding a first composition comprising preferably the imine compound and a second separate composition comprising the compound including a soft electrophilic centre. Suitably the first and second compositions are added separately and concurrently to the industrial or environmental material.

Suitably the amount of (a) the imine compound and (b) the compound including a soft electrophilic centre used in the method of the second aspect is determined based on the estimated concentration of acidic sulfide species present in the industrial or environmental material.

In preferred embodiments from 0.1 to 20 molar equivalents of (a) the imine compound is added to industrial or environmental material per mole of acidic sulfide species, preferably from 0.5 to 10 molar equivalents.

In preferred embodiments from 0.1 to 20 molar equivalent of (b) the compound including a soft electrophilic centre is added to industrial or environmental material per molar of acidic sulfide species, preferably from 0.5 to 10 molar equivalents.

Suitably the molar ratio of (a) the imine compound to (b) the compound including a soft electrophilic centre is from 10:1 to 1:100, preferably from 5:1 to 1:50, for example from 2:1 to 1:10.

In some embodiments the composition comprising the imine compound and the composition comprising the compound with a soft electrophilic centre are admixed with the industrial or environmental material in an amount of from 0.1 ppm to 10000 ppm, preferably in an amount of from 10 ppm to 1000 ppm.

The method of the second aspect may suitably be carried out using a product of the third aspect.

In some embodiments the imine compound and the compound including a soft electrophilic centre may be provided in a single composition. Such a composition may be in the form of an emulsion and may optionally further comprise a surfactant. Preferably the imine compound and the compound including a soft electrophilic centre are provided in separate compositions.

The product of the third aspect suitably comprises:
(a) a first composition comprising an imine compound; and
(b) a second composition comprising a compound including a soft electrophilic centre.

The first composition comprising the imine compound may comprise a mixture of two or more imine compounds. In some embodiments the composition further comprises a solvent. Preferred solvents are organic solvents.

The first composition may comprise a mixture of two or more solvents.

Suitable organic solvents include aromatic and aliphatic solvents, including oxygenated solvents and halogenated solvents. Preferred solvents are alcohols and hydrocarbon solvents, suitably mixtures of aliphatic and/or aromatic hydrocarbon solvents.

Suitably the imine compound is present in the first composition in an amount of from 1 to 100 wt %, preferably 5 to 100 wt %, for example 10 to 100 wt %.

The second composition comprising the compound including a soft electrophilic centre may comprise a mixture of two or more such compounds.

In some embodiments the composition further comprises a solvent. Preferred solvents are water, alcohols and other organic solvents.

The second composition may comprise a mixture of two or more solvents.

Suitable organic solvents include aromatic and aliphatic solvents, including oxygenated solvents and halogenated solvents. Preferred solvents are water, alcohols and hydrocarbon solvents, suitably mixtures of aliphatic and/or aromatic hydrocarbon solvents.

Suitably the compound including a soft electrophilic centre is present in the second composition in an amount of from 1 to 100 wt %, preferably 5 to 100 wt %, for example 10 to 100 wt %.

The first and second compositions of the product of the third aspect of the present invention may each further comprise one or more further components. In some embodiments a scale inhibitor may be present in the first composition and/or in the second composition. Suitable scale inhibitors are known to those skilled in the art.

In some embodiments a corrosion inhibitor may be present in the first composition and/or in the second composition. Suitable corrosion inhibitors are known to those skilled in the art.

Thus in some embodiments the product of the third aspect may further comprise (c) a scale inhibitor and/or a corrosion inhibitor.

The first and second compositions may each further comprise one or more further components selected from biocides, friction reducers, drag reducing agents, surfactants, foaming agents, carbon dioxide scavengers, oxygen scavengers and metal scavengers.

The use of the first aspect and the method of the second aspect are suitably carried out using a first composition comprising an imine compound and a second composition comprising a compound including a soft electrophilic centre. These compositions are suitably as defined in relation to the third aspect.

In some embodiments the product of the third aspect may comprise means for delivering the first composition comprising (a) the imine compound and/or means for delivering the composition comprising (b) the compound including a soft electrophilic centre into the industrial or environmental material. Suitable means will be known to the person skilled in the art and include, for example injection means.

The first and/or second compositions may be injected via injection quills. In some preferred embodiments a continuous injection pump with a higher number of strokes per minute can be used. Suitable means of monitoring the quantity and/or injection rate of the compositions would also be used.

The invention will now be further described with reference to the following non-limiting examples.

### EXAMPLE 1

The thermal stability of various combinations of imine compound (a) and a compound including a soft electrophilic centre (b) as hydrogen sulfide scavengers was tested according to the following procedure:

Na₂S.xH₂O (60% scales, 100 mg) is dissolved in water (5 ml) in a reaction vessel. Caromax (RTM) (50 ml) is added to make a biphasic mixture and the reaction vessel is tightly sealed. HCI (0.5 M, 3.08 ml) is injected and the mixture stirred for 5 minutes to generate H₂S (ca. 500 mg/l in the caromax phase). 1 ml of a the caromax phase (containing H₂S) is taken via syringe and added to caromax (9 ml) in a sealed vessel. Thus the solution contained approximately 50mg/l of H₂S. Component (a) (5 molar equivalents relative to H₂S) and component (b) (5 molar equivalents relative to H₂S) were then injected and the mixture heated to 75° C. for 30 minutes with stirring. After cooling to room temperature the scavenged mixture was poured into a transparent pressure vessel. An H₂S indicator was placed inside the pressure vessel (not touching the liquid) and the system sealed. The pressure vessel was then heated (5° C. per minute) to a maximum temperature of 180° C. or until the indicator showed the presence of H₂S in the gas phase. The results are shown in Table 1.

TABLE 1

| | | Compound | | | |
|---|---|---|---|---|---|
| | | including | | Temperature | |
| | | a soft | | at which | |
| | Imine | electrophilic | | H₂S is | |
| Example | Compound (a) | centre (b) | Solvent | re-released | |
| 1 | t-octyl imine | None | Caromax | 140° | C. |
| 2 | t-octyl imine | N-butyl | Caromax | 175° | C. |
| | | maleimide | | | |
| 3 | t-octyl imine | Propenal | Caromax | >180° | C. |
| 4 | t-octyl imine | Maleimide | Caromax | 180° | C. |
| 5 | t-octyl imine | bis(chloro- | Caromax | 180° | C. |
| | | methyl)di- | | | |
| | | methyl | | | |
| | | silane | | | |
| 6 | t-octyl imine | 2-iodo- | Caromax | >180° | C. |
| | | 1,1,1,2,3,3,3- | | | |
| | | heptafluoro- | | | |
| | | propane | | | |
| 7 | t-octyl imine | 2-vinyl- | Caromax | >180° | C. |
| | | 1,3-dioxolane | | | |
| 8 | Sulfix 9200 | None | Caromax | 140° | C. |
| 9 | Sulfix 9200 | Propenal | Caromax | 175° | C. |
| 10 | N-tert-butyl | Propenal | Caromax | >180° | C. |
| | 2-ethyl | | | | |
| | hexyl imine | | | | |
| 11 | t-octyl imine | Maleic | Caromax | >180° | C. |
| | | anhydride | | | |
| 12 | t-octyl imine | 3-buten-2-one | Caromax | 180° | C. |
| 13 | t-octyl imine | 3-chloro-2- | Caromax | 175° | C. |
| | | butanone | | | |
| 14 | t-octyl imine | Dimethyl | Caromax | >180° | C. |
| | | bromomalonate | | | |

Suffix 9200 is a terminal imine formed by reacting Primene 81R (RTM, a C12-C14 tertiary alkyl amine) and formaldehyde.

### EXAMPLE 2

The rate at which compounds and combinations of compounds scavenge hydrogen sulfide was measured as follows:

Na₂S.xH₂O (60% scales, 100 mg) is dissolved in water (5 ml) in a reaction vessel. Caromax (RTM) (50 ml) is added to make a biphasic mixture and the reaction vessel is tightly sealed. HCI (0.5 M, 3.08 ml) is injected and the mixture stirred for 5 minutes to generate H₂S (ca. 500 mg/l in the caromax phase). 1 ml of a the caromax phase (containing H₂S) is taken via syringe and added to caromax (19 ml) in a sealed vessel. Thus the solution contained approximately 25 mg/l of hydrogen sulfide. The mixture was heated to 30° C. with stirring and an aliquot (0.3 ml) was removed via syringe and the liquid-phase H₂S content determined using a colourimetric test. This is the time=0 reading. Component (a) (5 molar equivalents relative to H₂S) and component (b) (5 molar equivalents relative to H₂S) were then injected and the scavenging monitored by testing aliquots of the mixture at set time intervals (typically 1, 5, 10, 20 and 30 minutes).

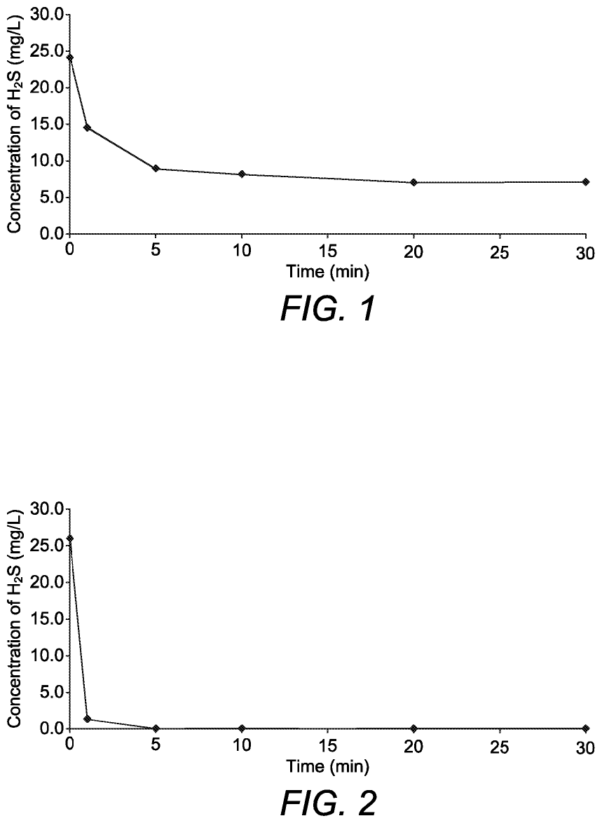

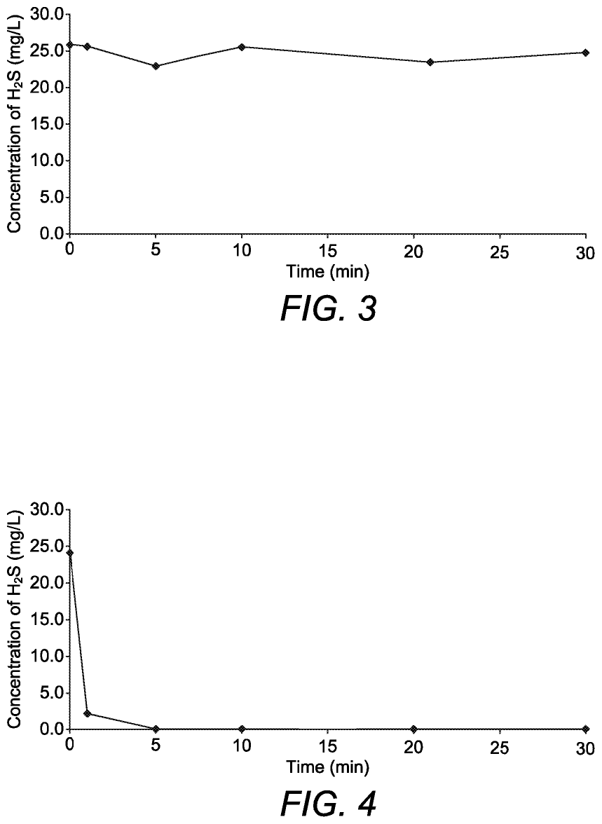

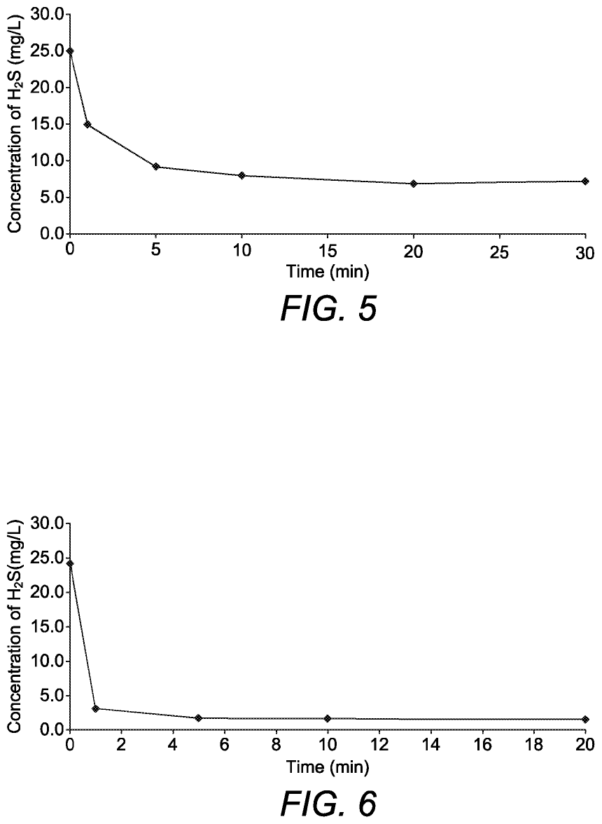

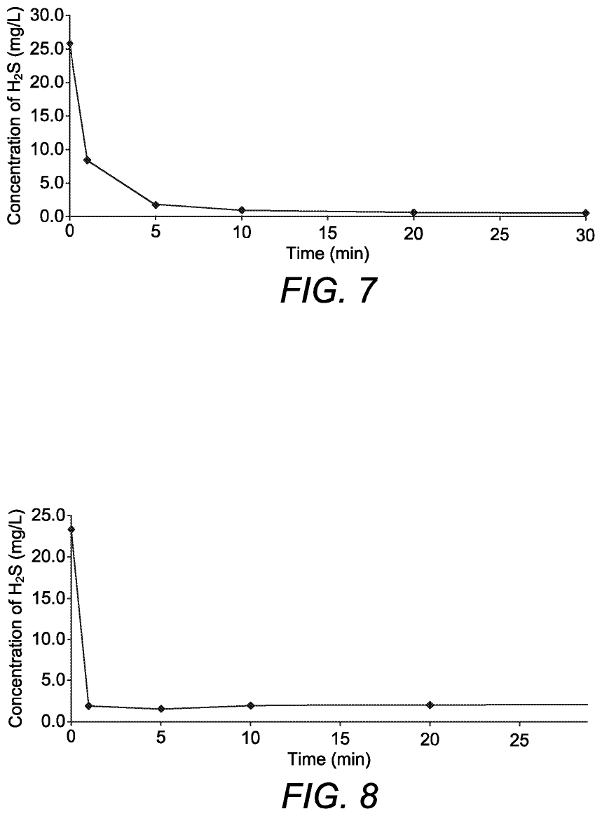

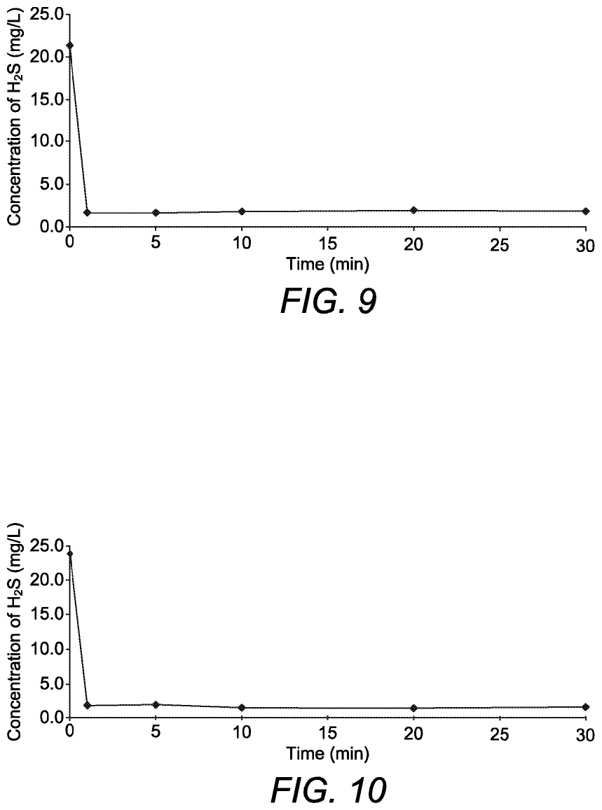

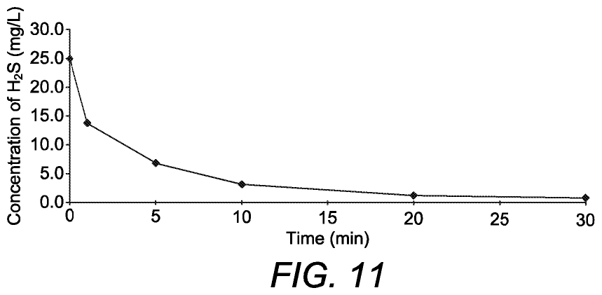

Table 2 and FIGS. 1 to 11 show how the using a combination of propenal or maleimide and a base increases the rate compared to the use of either component alone.

TABLE 2

| | Compound | | | | | | | |
|---|---|---|---|---|---|---|---|---|
| Imine | with soft | | | | | | | Figure |
| com- | electrophilic | 0 | 1 | 5 | 10 | 20 | 30 | num- |
| pound | centre (b) | min | min | min | min | min | min | ber |
| t-octyl | none | 24.0 | 14.4 | 8.9 | 8.1 | 6.9 | 7.1 | 1 |
| imine | | | | | | | | |
| t-octyl | propenal | 25.8 | 1.2 | 0.1 | 0.0 | 0.0 | 0.0 | 2 |
| imine | | | | | | | | |
| None | propenal | 25.8 | 25.7 | 23.1 | 25.6 | 23.6 | 24.8 | 3 |
| Sulfix | propenal | 24.0 | 2.3 | 0.0 | 0.0 | 0.0 | 0.0 | 4 |
| 9000 | | | | | | | | |
| Sulfix | none | 24.9 | 14.9 | 9.2 | 7.9 | 6.8 | 7.1 | 5 |
| 9000 | | | | | | | | |
| t-octyl | Maleic | 24.6 | 3.0 | 1.6 | 1.5 | 1.4 | | 6 |
| imine | anhydride | | | | | | | |
| t-octyl | Maleimide | 26.1 | 8.3 | 1.7 | 0.7 | 0.5 | 0.3 | 7 |
| imine | | | | | | | | |
| t-octyl | Bromoacetic | 23.3 | 1.8 | 1.6 | 1.9 | 2.0 | 2.1 | 8 |
| imine | acid | | | | | | | |
| t-octyl | Chloroacetic | 23.1 | 1.6 | 1.6 | 1.7 | 1.9 | 1.8 | 9 |
| imine | acid | | | | | | | |
| t-octyl | Chloroacetic | 23.8 | 1.7 | 1.9 | 1.4 | 1.3 | 1.5 | 10 |
| imine | anhydride | | | | | | | |
| t-octyl | Dimethyl | 24.7 | 13.6 | 6.6 | 3.0 | 1.0 | 0.7 | 11 |
| imine | bromo- | | | | | | | |
| | malonate | | | | | | | |

1. (canceled)

2. A method of scavenging an acidic sulfide species from an industrial or environmental material, the method comprising contacting the material with:
(a) an imine compound; and
(b) a compound including a soft electrophilic centre.

3. A product for scavenging acid sulfide species, the product comprising:
(a) an imine compound; and
(b) a compound including a soft electrophilic centre.

4. The method according to claim 2 wherein component (a) comprises one or more imine compounds of formula (I): 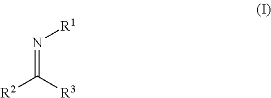
in which each of R¹, R² and R³ is independently selected from hydrogen or an optionally substituted alkyl, alkenyl, aryl, alkaryl or aralkyl group;
wherein at least one of R¹, R² and R³ is not hydrogen.

5. The method according to claim 2 wherein component (a) comprises one or more imine compounds prepared by the reaction of an with one or more compounds of formula (II): 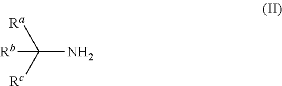
and an aldehyde selected from formaldehyde (or paraformaldehyde) and 2-ethyl hexanal wherein each of R^{a}, R^{b} and R^{c} is an unsubstituted alkyl group and the groups R^{a}, R^{b} and R^{c} together comprise 3 to 22 carbon atoms.

6. The method according to claim 2 wherein component (a) comprises an imine compound selected from one or more compounds of formula (III), (IV) or (V): 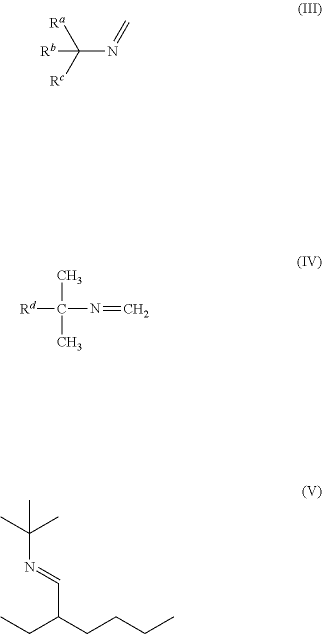
wherein groups R^{a}, R^{b} and R^{c} together comprise 12 to 14 carbon atoms; and R^{d} is a (1-5C)alkyl group.

7. The method according to claim 2 wherein component (a) comprises an imine compound selected from one or more of a compound of formula (III), the compound of formula (V) and tert-octylimine.

8. The method according to claim 2 wherein component (b) comprises a compound including a soft electrophilic centre selected from halogenated compounds including an electron deficient carbon atom, bromo-compounds, iodo-compounds, chloro-compounds, silanes and α, β-unsaturated carbonyl compounds or a reactive equivalent thereof.

9. The method according to claim 2 wherein component (b) comprises a compound including a soft electrophilic centre selected from bromo-compounds, iodo-compounds, silanes and α, β-unsaturated carbonyl compounds or a reactive equivalent thereof.

10. The method according to claim 2 wherein component (b) comprises a compound including a soft electrophilic centre selected from propenal, maleimide, N-butyl maleimide, bis(chloromethyl)dimethyl silane, 2-iodo-1,1,1,2,3,3,3-heptafluoropropane, maleic anhydride and 2-vinyl-1,3-dioxolane.

11. The method according to claim 2 wherein component (b) comprises a compound including a soft electrophilic centre selected from propenal, maleimide, N-butyl maleimide, bis(chloromethyl)dimethyl silane, 2-iodo-1,1,1,2,3,3,3 -heptafluoropropane and 2-vinyl-1,3-dioxolane.

12. The method according to claim 2 wherein the imine compound and the compound including a soft electrophilic centre are provided in a single composition or in separate compositions.

13. The method according to claim 12 wherein the imine compound and the compound including a soft electrophilic centre are provided in separate compositions.

14. The method according to claim 2 wherein the industrial or environmental material is contacted concurrently with a composition comprising an imine compound and a composition comprising a compound including an electrophilic centre.

15. The method according to claim 2 wherein the industrial or environmental material is selected from crude oil, produced water, petroleum refinery liquids, coke, asphalt or bitumen, used fracturing fluids, used water-flooding fluids, brines, geothermal fluids or sour gas.

16. The method according to claim 2 in which the acidic sulfide species is hydrogen sulfide.

17. The method according to claim 2 which scavenges and retains hydrogen sulfide at temperatures in excess of 150° C.

18. The product according to claim 3 which further comprises (c) a scale inhibitor and/or a corrosion inhibitor.

19. The product according to claim 3 which further comprises (c) one or more components selected from biocides, friction reducers, drag reducing agents, surfactants, foaming agents, carbon dioxide scavengers, oxygen scavengers and metal scavengers.

20. The product according to claim 3 which further comprises means for delivering the composition comprising the imine compound and/or the composition comprising the compound including a soft electrophilic centre to the industrial or environmental material.

21. (canceled)

22. The product according to claim 3 wherein component (a) comprises one or more imine compounds of formula (I): 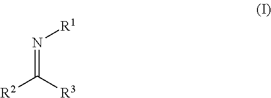
in which each of R¹, R² and R³ is independently selected from hydrogen or an optionally substituted alkyl, alkenyl, aryl, alkaryl or aralkyl group;
wherein at least one of R¹, R² and R³ is not hydrogen.

23. The product according to claim 3 wherein component (a) comprises one or more imine compounds prepared by the reaction of an with one or more compounds of formula (II): 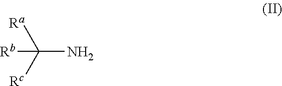
and an aldehyde selected from formaldehyde (or paraformaldehyde) and 2-ethyl hexanal wherein each of R^{a}, R^{b} and R^{c} is an unsubstituted alkyl group and the groups R^{a}, R^{b} and R^{c} together comprise 3 to 22 carbon atoms.

24. The product according to claim 3 wherein component (a) comprises an imine compound selected from one or more compounds of formula (III), (IV) or (V): 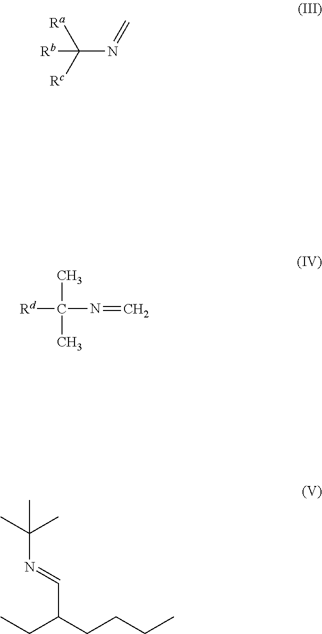
wherein groups R^{a}, R^{b} and R^{c} together comprise 12 to 14 carbon atoms; and R^{d} is a (1-5C)alkyl group.

25. The product according to claim 3 wherein component (a) comprises an imine compound selected from one or more of a compound of formula (III), the compound of formula (V) and tert-octylimine.

26. The product according to claim 3 wherein component (b) comprises a compound including a soft electrophilic centre selected from halogenated compounds including an electron deficient carbon atom, bromo-compounds, iodo-compounds, chloro-compounds, silanes and α, β-unsaturated carbonyl compounds or a reactive equivalent thereof.

27. The product according to claim 3 wherein component (b) comprises a compound including a soft electrophilic centre selected from bromo-compounds, iodo-compounds, silanes and α, β-unsaturated carbonyl compounds or a reactive equivalent thereof.

28. The product according to claim 3 wherein component (b) comprises a compound including a soft electrophilic centre selected from propenal, maleimide, N-butyl maleimide, bis(chloromethyl)dimethyl silane, 2-iodo-1,1,1,2,3,3,3-heptafluoropropane, maleic anhydride and 2-vinyl-1,3-dioxolane.

29. The product according to claim 3 wherein component (b) comprises a compound including a soft electrophilic centre selected from propenal, maleimide, N-butyl maleimide, bis(chloromethyl)dimethyl silane, 2-iodo-1,1,1,2,3,3,3-heptafluoropropane and 2-vinyl-1,3-dioxolane.

30. The product according to claim 3 wherein the imine compound and the compound including a soft electrophilic centre are provided in a single composition or in separate compositions.

31. The product according to claim 3 wherein the imine compound and the compound including a soft electrophilic centre are provided in separate compositions.

32. The product according to claim 3 which scavenges and retains hydrogen sulfide at temperatures in excess of 150° C.
